(19) United States
(12) Patent Application Publication
(10) Pub. No.: US 2026/0221453 A1
(43) Pub. Date: Jul. 30, 2026

(54) ELECTRODE AND ELECTRODE ASSEMBLY INCLUDING SAME

(71) Applicant: SAMSUNG SDI CO., LTD., Yongin-si, Gyeonggi-do (KR)

(72) Inventors: Jisang RYU, Yongin-si (KR); Tongwoo KIM, Yongin-si (KR); Hyunki JEONG, Yongin-si (KR); Jungkun KIM, Yongin-si (KR); Deokhwan SEO, Yongin-si (KR)

(21) Appl. No.: 19/142,757

(22) PCT Filed: Apr. 19, 2023
(86) PCT No.: PCT/KR2023/005279

§ 371 Date: Jul. 31, 2025

(30) Foreign Application Priority Data
Dec. 27, 2022 (KR) 10-2022-0186356

(51) Int. Cl. H01M 4/62; H01M 4/36; H01M 10/04

(52) U.S. Cl. CPC H01M 4/623; H01M 4/366; H01M 10/0431

(57) ABSTRACT

An electrode includes: a substrate; a first active material layer and a first insulating layer that are disposed on one surface of the substrate; and a second active material layer and a second insulating layer that are disposed on the other surface of the substrate. The first insulating layer and the second insulating layer have different colors.

### TECHNICAL FIELD

The present disclosure relates to an electrode, and more particularly, to an electrode for a rechargeable battery and an electrode assembly including the same.

### BACKGROUND ART

Demand for a rechargeable battery as an energy source is increasing according to technology development and demand for a mobile device.

A cylindrical rechargeable battery among rechargeable batteries includes an electrode assembly formed by disposing electrodes on both surfaces of a separator to wind the disposed electrodes on both surfaces of the separator in a form of a jelly roll, a center pin disposed at a hollow portion of a center of the electrode assembly, a case including the electrode assembly, and a cap assembly sealing an open side of the case.

The electrode assembly in the form of the jelly roll is formed by being repeatedly wound around the center pin. Therefore, a radius of curvature on an inner surface of the electrode and a radius of curvature on an outer surface of the electrode are different. To solve the problem, an active material layer is formed by pattern coating, but as a size of the battery is increased, a stripe coating method in which an active material is continuously formed is applied rather than the pattern coating.

In the stripe coating, different coatings are performed according to an inner surface (i.e., a surface relatively close to a center of the electrode assembly) and an outer surface (i.e., a surface relatively far from the center of the electrode assembly) of the substrate in consideration of a radius of curvature of a circular battery, but due to a characteristic of a process in which the active material layer is continuously applied and the applied active material layer is wound on a roll, it is not easy to detect whether a surface on which the active material layer is coated is the inner surface or the outer surface of the substrate during the process.

Because it is not easy to detect the inner and the outer surfaces of the substrate, during a winding process or when re-winding after the winding process, the inner surface and the outer surface of the substrate may be changed and input so that there is a problem of increasing time and cost of the process.

### DISCLOSURE

### Technical Problem

The present disclosure provides an electrode capable of reducing a risk in which inner and outer surfaces of a substrate are changed and incorrectly input during a rewinding process by easily distinguishing the inner and outer surfaces of the substrate with the naked eye during stripe coating, and an electrode assembly including the electrode.

### Technical Solution

An electrode according to embodiments of the present disclosure includes: a substrate; a first active material layer and a first insulating layer that are disposed on one surface of the substrate; and a second active material layer and a second insulating layer that are disposed on the other surface of the substrate. The first insulating layer and the second insulating layer have different colors.

The first insulating layer and the second insulating layer may include pigments with different colors.

The first insulating layer and the second insulating layer may include a pigment and an insulating material, and the insulating material may include one of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU).

The first insulating layer and the second insulating layer may include different materials.

The first insulating layer may include a pigment and an insulating material, the insulating material may include one of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU), and the second insulating layer may include a ceramic.

The first insulating layer and the second insulating layer may have different widths.

The first insulating layer and the second insulating layer may be respectively adjacent to the first active material layer and the second active material layer, and may be disposed at an edge of the substrate.

The first insulating layer may be disposed at both sides of the first active material layer, the second insulating layer may be disposed at both sides of the second active material layer, and the first insulating layer and the second insulating layer may be continuously disposed along the first active material layer and the second active material layer, respectively.

An electrode assembly according to embodiments includes a positive electrode, a separator, and a negative electrode that are stacked and wound. At least one of the positive electrode and the negative electrode includes a substrate, a first active material layer and a first insulating layer that are disposed on one surface of the substrate, and a second active material layer and a second insulating layer that are disposed on the other surface of the substrate, and the first insulating layer and the second insulating layer have different colors.

The first insulating layer and the second insulating layer may include pigments with different colors.

The first insulating layer and the second insulating layer may include a pigment and an insulating material, and the insulating material may include one of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU).

The first insulating layer and the second insulating layer may include different materials.

The first insulating layer may include a pigment and an insulating material, the insulating material may include one of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU), and the second insulating layer may include a ceramic.

The first insulating layer and the second insulating layer may have different widths.

The first insulating layer and the second insulating layer may be respectively adjacent to the first active material layer and the second active material layer, and may be disposed at an edge of the substrate.

The first insulating layer may be disposed at both sides of the first active material layer, the second insulating layer may be disposed at both sides of the second active material layer, and the first insulating layer and the second insulating layer may be continuously disposed along the first active material layer and the second active material layer, respectively.

An electrode according to other embodiments includes: a substrate; an active material layer that is disposed on at least one surface of the substrate; and an insulating layer that is adjacent to the active material layer and is disposed on one surface of the substrate. The insulating layer includes a ceramic or has a color identifiable with the naked eye.

### Advantageous Effects

Because an insulating layer capable of being distinguished with the naked eye is disposed at an edge of an electrode, an inner surface and an outer surface of the electrode may be easily identified in a winding-type electrode assembly formed by being repeatedly wound. Therefore, a risk in which the inner and outer surfaces are changed and incorrectly input may be reduced.

### DESCRIPTION OF THE DRAWINGS

FIG. 1 is a cross-sectional view of a rechargeable battery according to embodiments of the present disclosure.

FIG. 2 is a cross-sectional view illustrating a portion of an electrode assembly included in FIG. 1.

FIGS. 3 to 5 are cross-sectional views illustrating a portion of an electrode assembly according to embodiments of the present disclosure.

### MODE FOR INVENTION

Embodiments of the present disclosure will be described more fully hereinafter with reference to the accompanying drawings so that those skilled in the art could easily implement the embodiments. The present disclosure may be modified in various ways, all without departing from the spirit or scope of the present disclosure.

In the drawings, a size and a thickness of each element are arbitrarily illustrated for ease of description, and the present disclosure is not necessarily limited to what is illustrated in the drawings.

In the drawings, the thicknesses of some layers and areas are exaggerated for clarity. In the drawings, for ease of description, the thicknesses of some layers and areas are exaggerated. It should be understood that when an element such as a layer, a film, a region, or a plate is referred to as being “on” or “above” another element, it may be directly on the other element, or an intervening element may also be present.

Unless explicitly stated to the contrary, the word “comprise” and variations such as “comprises” and “comprising” should be understood to imply the inclusion of stated elements but not the exclusion of any other elements.

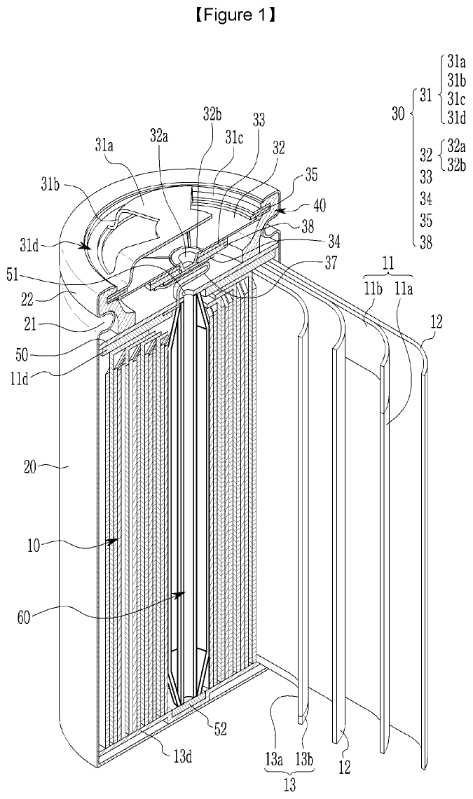

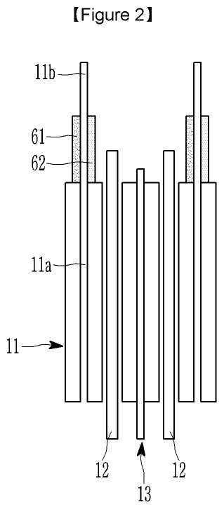

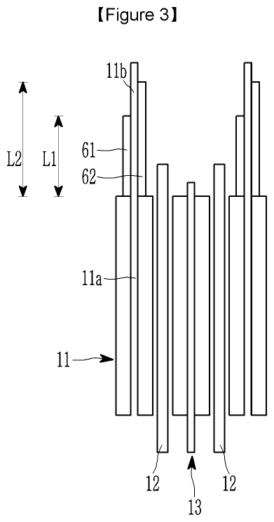

FIG. 1 is a cross-sectional view of a rechargeable battery according to embodiments of the present disclosure, and FIG. 2 is a cross-sectional view illustrating a portion of an electrode assembly included in FIG. 1. FIGS. 3 to 5 are cross-sectional views illustrating a portion of an electrode assembly according to embodiments of the present disclosure.

As shown in FIG. 1, the rechargeable battery according to the embodiments of the present disclosure may include an electrode assembly 10, a case 20 including the electrode assembly 10, a cap assembly 30 coupled to an opening of the case 20 through a gasket and electrically connected to the electrode assembly 10, an insulating plate 50 provided between the cap assembly 30 and the electrode assembly 10, and a center pin 60 disposed at a center of the electrode assembly 10.

The electrode assembly 10 may include a first electrode 11, a separator 12, a second electrode 13, and a separator 12 that are sequentially stacked. The electrode assembly 10 may be a cylindrical jelly roll in which the first electrode 11, the separator 12, the second electrode 13, and the separator 12 are stacked and then wound around the center pin 60.

The first electrode 11 may include a first coating portion 11a and a first uncoated portion 11b. The first coating portion 11a may be a portion where an active material layer (e.g., transition metal oxide such as LiCoO₂, LiNiO₂, or LiMn₂O₄) is formed on both surfaces of a substrate formed of a thin metal plate to be used as a conductive current collector. The first uncoated portion 11b may be a portion where a surface of the substrate is exposed because the active material layer is not formed on the substrate. The second electrode 13 may include a second coating portion 13a and a second uncoated portion 13b. The second coating portion 13a may be a portion where an active material layer (e.g., graphite or carbon) is formed on both surfaces of a substrate formed of a thin metal plate to be used as a conductive current collector. The second uncoated portion 13b may be a portion where the substrate is exposed because the active material layer is not formed at the substrate.

The first uncoated portion 11b and the second uncoated portion 13b may be disposed opposite to each other. The first electrode 11 may be a positive electrode, and the second electrode 13 may be a negative electrode. A substrate of the first electrode 11 may be aluminum (Al), and a substrate of the second electrode 13 may be copper (Cu), nickel (Ni), or an alloy of copper and nickel.

The separator 12 may be disposed between the first electrode 11 and the second electrode 13, and may be insulated between the first electrode 11 and the second electrode 13. The separator 12 may use polyethylene, polypropylene, polyvinylidene fluoride, or a multilayer film of two or more layers thereof, and may use a mixed multilayer film such as a polyethylene/polypropylene 2-layer separator, a polyethylene/polypropylene/polyethylene 3-layer separator, a polypropylene/polyethylene/polypropylene 3-layer separator, or the like.

In a jelly roll state, a first electrode current collector 11d may be connected to the first uncoated portion 11b of the electrode assembly 10, and a second electrode current collector 13d may be connected to the second uncoated portion 13b of the electrode assembly 10.

The second electrode current collector 13d may be in contact with the case 20. The first electrode current collector 11d may be formed to be smaller than a width of the second electrode current collector 13d so as not to be in contact with the case 20.

The first uncoated portion 11b may be bent toward the center pin 60 that is the center of the electrode assembly 10, and adjacent first uncoated portions 11b may be stacked overlapping each other to be electrically connected to each other. The first uncoated portion 11b may be electrically connected to the first electrode current collector 11d in an overlapping state.

The first uncoated portion 11b may include one surface contacting and electrically connected to the first electrode current collector 11d and the other surface facing an end portion (e.g., an upper end portion based on FIG. 1) of the second electrode 13. The other surface of the first uncoated portion 11b may be spaced apart from the end portion of the second electrode 13. The one surface may be an outer surface of the first uncoated portion 11b, and the other surface may be an inner surface of the first uncoated portion 11b.

Referring to FIG. 1 and FIG. 2, a first insulating layer 61 and a second insulating layer 62 having different colors may be disposed on one surface and the other surface of the substrate in the first uncoated portion 11b, respectively. A fact that they have different colors may mean that a difference between them is distinguished with the naked eye. For example, the first insulating layer 61 may have a yellow color, and the second insulating layer 62 may have a black color or a green color that is completely different from the yellow color. However, the present disclosure is not limited thereto, and the difference between them distinguished with the naked eye may include all differences such as different concentrations for their specific color, different chromas for their specific color, different brightnesses for their specific color, different reflectivities for their specific color, and different textures for their specific color.

Two active material layers included in the first electrode 11 may be divided into a first active material layer in contact with the first insulating layer 61 and a second active material layer in contact with the second insulating layer 62. For convenience of description, FIG. 2 shows a state before the first uncoated portion 11b is bent.

The first insulating layer 61 and the second insulating layer 62 may include one selected from the group consisting of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU), but the present disclosure is not limited thereto, and the first insulating layer 61 and the second insulating layer 62 may include any material that may exhibit an identifiable color by mixing pigments.

The first insulating layer 61 and the second insulating layer 62 may include different pigments to exhibit different colors.

The first insulating layer 61 and the second insulating layer 62 may include a ceramic having a color without mixing a separate pigment, and for example, the first insulating layer 61 and the second insulating layer 62 may include one selected from the group consisting of alumina (Al₂O₃), zirconia (ZrO₂), titanium oxide (TiO₂), and silica (SiO₂).

The first insulating layer 61 and the second insulating layer 62 may be made of different materials that may be distinguished with the naked eye. For example, the first insulating layer 61 may be made of transparent polyimide, and the second insulating layer 62 may be made of a white ceramic.

In the embodiments, one surface and the other surface of the first uncoated portion 11b are distinguished using colors of the first insulating layer 61 and the second insulating layer 62, but as shown in FIG. 3, one surface and the other surface of the first uncoated portion 11b may be distinguished by making a first insulating layer 61 and a second insulating layer 62 have different widths L1 and L2.

The width L1 of the first insulating layer 61 and the width L2 of the second insulating layer 62 may be defined as a length extending from an end portion adjacent to the first coating portion 11a to an end portion of the first uncoated portion 11b exposed to the outside. The width L1 of the first insulating layer 61 may be different from the width L2 of the second insulating layer 62 so as to be identifiable with the naked eye.

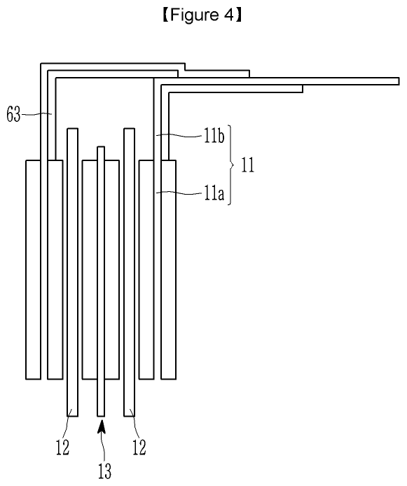

As shown in FIG. 4, an insulating layer 63 may be formed on one of one surface and the other surface of the first uncoated portion 11b so that one surface and the other surface of the first uncoated portion 11b are distinguished. The insulating layer 63 may be formed of an insulating layer having a color or a texture that is identifiable with the naked eye such as an insulating material including a ceramic or a pigment.

The insulating layer 63 may be disposed on the other surface of the first uncoated portion 11b facing an end portion (e.g., an upper end portion based on the drawings) of the second electrode 13. This is to prevent a short circuit by contacting the second electrode 13 when the uncoated portion is folded to be fixed by welding. The insulating layer may not be disposed at a portion where adjacent uncoated portions overlap each other to be electrically connected.

In the above-described embodiments, the first insulating layer 61 and the second insulating layer 62 may have different colors or different widths, and the insulating layer 63 may be disposed on only one surface of the first uncoated portion 11b. By the configuration, one surface and the other surface of the first electrode 11 may be easily distinguished.

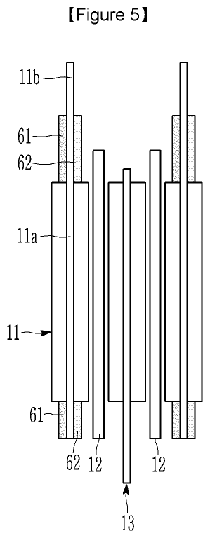

In FIGS. 2 to 4, the first insulating layer 61, the second insulating layer 62, and the insulating layer 63 are disposed on one surface of the active material layer, but their positions are not limited thereto. For example, referring to FIG. 5, a first insulating layer 61 may be disposed at both sides of a first active material layer with the first active material layer interposed therebetween, and the second insulating layer 62 may be disposed at both sides of a second active material layer with the second active material layer interposed therebetween. The first insulating layer 61 may be continuously disposed along the first active material layer, and the second insulating layer 62 may be continuously disposed along the second active material layer.

Referring back to FIG. 1, a lead tab 37 may be electrically connected to the first electrode current collector 11d. One end of the lead tab 37 may be connected to the first electrode current collector 11d by welding, and the other end of the lead tab 37 may be electrically connected to the cap assembly 30. The lead tab 37 may be bent so that one surface of the lead tab 37 faces the electrode assembly 10 in order to increase a contact area with the cap assembly 30.

The insulating plate 50 having an opening exposing the center pin 60 may be disposed on the first electrode current collector 11d. The insulating plate 50 may be formed to be larger than the first electrode current collector 11d so that the insulating plate 50 is in contact with an inner surface of the case 20. If the insulating plate 50 is formed to be larger than the first electrode current collector 11d, a predetermined gap may be formed between the first electrode current collector 11d and the case 20 by a width at which the insulating plate 50 protrudes out of the first electrode current collector 11d. The gap may prevent a short circuit between the first electrode current collector 11d and the case 20.

The lead tab 37 may be in contact with a first auxiliary plate 34 of the electrode assembly 10 described later through an opening 51 of the insulating plate 50, and may be electrically connected to the first auxiliary plate 34.

Because the electrode assembly 10 is wound around the center pin 60, the center pin 60 may be disposed at a center of the electrode assembly 10, and may be disposed parallel to a direction in which the electrode assembly 10 is inserted into the case 20.

The center pin 60 may be minimally deformed or may maintain a shape close to a pre-deformation shape if the center pin 60 receives an entire compressive load or a local impact load acting on the outside of the rechargeable battery. The center pin 60 may have a hollow circular pipe shape. For example, the center pin 60 may serve as a movement path for a gas internally generated. In some embodiments, the center pin 60 may be omitted.

The center pin 60 may be formed of a material (for example, a metal having conductivity) having a certain rigidity in order to be minimally deformed against an external impact. For example, the metal having conductivity may be steel, a steel alloy, aluminum, an aluminum alloy, or the like. When the center pin 60 is made of a metal having conductivity, both ends of the center pin 60 may be installed to be electrically insulated from the first electrode current collector 11d and the second electrode current collector 13d.

For example, an insulating pad 52 may be disposed between a lower end of the center pin 60 and the second electrode current collector 13d corresponding to the lower end of the center pin 60. An upper end of the center pin 60 may pass through a through hole formed at a center of the first electrode current collector 11d in an insulated state to be supported by the insulating plate 50. For example, the upper end of the center pin 60 may be spaced apart from the through hole of the first electrode current collector 11d, and an insulating member (not shown) may be interposed between the upper end of the center pin 60 and the first electrode current collector 11d. Therefore, a movement of the center pin 60 may be restricted in a length direction of the center pin 60, and the center pin 60 may maintain a stable state at a center of the electrode assembly 10.

One side of the case 20 may be open so that the electrode assembly 10 is inserted into the case 20 together with an electrolyte. The case 20 may be formed to have approximately the same shape as a jelly roll-shaped electrode assembly 10.

For example, the case 20 may include a circular bottom portion and a cylindrical side portion extending a predetermined length upward from the bottom portion. During an assembly process of the rechargeable battery, an upper portion of the cylindrical case may be opened. For example, during the assembly process of the rechargeable battery, the electrode assembly may be inserted into the cylindrical case, and then the electrolyte may be injected into the cylindrical case.

The electrolyte may allow a lithium ion generated by an electrochemical reaction in the first electrode 11 and the second electrode 13 to move. The electrolyte may include an organic solvent such as ethylene carbonate (EC), polycarbonate (PC), diethyl carbonate (DEC), or ethyl methyl carbonate (EMC), and a lithium salt such as LiPF₆ or LiBF₄. The electrolyte may be in a liquid, solid, or gel state.

The case 20 may be connected to the second electrode current collector 13d of the electrode assembly to function as a second electrode terminal of the rechargeable battery. For example, the case 20 may be formed of a conductive metal such as aluminum, aluminum alloy, or nickel-plated steel.

The cap assembly 30 may be disposed at an opening of the case 20, and may be coupled to the case 20 with a gasket 40 interposed between the cap assembly 30 and the case 20. The gasket 40 may insulate the case 20 and the cap assembly 30, and may seal the inside of the case 20 accommodating the electrode assembly 10 and the electrolyte.

The cap assembly 30 may include a cap plate 31, a positive temperature coefficient element 35, a vent plate 32, an insulating member 33, the first auxiliary plate 34, and a second auxiliary plate 38.

The first auxiliary plate 34 may be electrically connected to the lead tab 37 of the electrode assembly, and may be coupled to the lead tab 37 by welding.

The second auxiliary plate 38 may be stacked on the first auxiliary plate 34 to be electrically connected to the first auxiliary plate 34, and may be coupled to the first auxiliary plate 34 by welding. The second auxiliary plate 38 may be disposed at a center of the electrode assembly 10 corresponding to the center pin 60, and may have a through hole exposing the first auxiliary plate 34.

The vent plate 32 may be disposed above the second auxiliary plate 38 with the insulating member 33 interposed between the vent plate 32 and the second auxiliary plate 38. An edge of the vent plate 32 may be inserted into the gasket 40 to be coupled to the case 20.

The vent plate 32 may include a vent 32a disposed at a portion corresponding to the center pin 60. The vent 32a may protrude from the vent plate 32 toward the electrode assembly 10, and may be in contact with the first auxiliary plate 34 through a through hole to be electrically connected to the first auxiliary plate 34. The vent plate 32 may have a notch 32b around the vent 32a that guides breakage of the vent 32a.

The vent 32a may be broken under a predetermined pressure condition to release an internal gas to the outside and block electrical connection with the first auxiliary plate 34. For example, when an internal pressure of the case 20 rises due to generation of a gas, the notch 32b may be broken in advance so that the gas is discharged to the outside through an exhaust port 31d to be described later. Thus, explosion of the rechargeable battery may be prevented.

For example, if an abnormal reaction continues so that the vent 32a is damaged, an electrical connection between the vent plate 32 and the first auxiliary plate 34 may be disconnected. In some embodiments, an electrical connection between the cap plate 31 electrically connected to the vent plate 32 and the first auxiliary plate 34 may be disconnected so that no more current flows.

The cap plate 31 may include a center plate 31a corresponding to the center pin 60 that is a center of the electrode assembly 10, a plurality of branch portions 31b extending from the center plate 31a toward the gasket 40, and a coupling plate 31c that connects ends of the branch portions 31b and is inserted into the gasket 40 to be coupled to the gasket 40. A space between adjacent branch portions 31b may be opened to the outside to form the exhaust port 31d for emitting an internal gas.

The branch portion 31b may be bent from the coupling plate 31c to be connected to the center plate 31a so that a center of the cap plate 31 protrudes outside the case 20. The cap plate 31 may be electrically connected to the first electrode current collector 11d through the vent plate 32, the second auxiliary plate 38, the first auxiliary plate 34, and the lead tab 37 so that the cap plate 31 is used as a first electrode terminal of the rechargeable battery. For example, if the center of the cap plate 31 is formed to protrude outside the case 20, a terminal connection with an external device may be facilitated.

In some embodiments, the positive temperature coefficient element 35 may be formed along the coupling plate 31c of the cap plate 31, and may be inserted into the gasket 40 in a stacked state between the coupling plate 31c of the cap plate 31 and an edge of the vent plate 32 to be coupled to the gasket 40.

The positive temperature coefficient element 35 may be installed between the cap plate 31 and the vent plate 32 to regulate current flow between the cap plate 31 and the vent plate 32 according to an internal temperature of the rechargeable battery.

If the internal temperature is within a predetermined range, the positive temperature coefficient element 35 may act as a conductor to electrically connect the cap plate 31 and the vent plate 32. However, if the internal temperature exceeds a predetermined temperature, the positive temperature coefficient element 35 may have an electrical resistance that increases to infinity. Thus, the positive temperature coefficient element 35 may block flow of a charging or discharging current between the cap plate 31 and the vent plate 32.

In a state where the electrode assembly 10 is inserted into the case 20, the vent plate 32, the positive temperature coefficient element 35, and the cap plate 31 may be inserted into the gasket 40 in a stacked state at an edge of the cap assembly 30, and then the cap assembly 30 may be inserted into an opening of the case 20.

For example, the cap assembly 30 may be fixed to the opening of the case 20 through a crimping process. In some embodiments, a beading portion 21 and a crimping portion 22 may be formed adjacent to the opening of the case 20. The beading portion 21 may be formed through a beading process. The beading portion 21 may have a structure in which the beading portion 21 is recessed toward a center in a radial direction of the case 20 at an upper side of the case 20 in a state in which the electrode assembly 10 is accommodated in the case 20, and the beading portion 21 may prevent the electrode assembly 10 from moving up and down.

The crimping portion 22 may have a structure that relatively protrudes from the beading portion 21 in a radial direction, and may be connected to the beading portion 21 so that the crimping portion 22 holds an outer circumferential surface of the cap assembly 30 and upper and lower surfaces connected to the outer circumferential surface with the gasket 40.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

1. An electrode comprising:
a substrate;
a first active material layer and a first insulating layer that are disposed on one surface of the substrate; and
a second active material layer and a second insulating layer that are disposed on the other surface of the substrate,
wherein the first insulating layer and the second insulating layer have different colors.

2. The electrode as claimed in claim 1, wherein the first insulating layer and the second insulating layer include pigments with different colors.

3. The electrode as claimed in claim 1, wherein the first insulating layer and the second insulating layer include a pigment and an insulating material, and the insulating material includes one of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU).

4. The electrode as claimed in claim 1, wherein the first insulating layer and the second insulating layer include different materials.

5. The electrode as claimed in claim 4, wherein the first insulating layer includes a pigment and an insulating material, the insulating material includes one of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU), and the second insulating layer includes a ceramic.

6. The electrode as claimed in claim 1, wherein the first insulating layer and the second insulating layer have different widths.

7. The electrode as claimed in claim 1, wherein the first insulating layer and the second insulating layer are respectively adjacent to the first active material layer and the second active material layer, and are disposed at an edge of the substrate.

8. The electrode as claimed in claim 7, wherein the first insulating layer is disposed at both sides of the first active material layer, the second insulating layer is disposed at both sides of the second active material layer, and the first insulating layer and the second insulating layer are continuously disposed along the first active material layer and the second active material layer, respectively.

9. An electrode assembly comprising a positive electrode, a separator, and a negative electrode that are stacked and wound,
wherein at least one of the positive electrode and the negative electrode includes a substrate, a first active material layer and a first insulating layer that are disposed on one surface of the substrate, and a second active material layer and a second insulating layer that are disposed on the other surface of the substrate, and the first insulating layer and the second insulating layer have different colors.

10. The electrode assembly as claimed in claim 9, wherein the first insulating layer and the second insulating layer include pigments with different colors.

11. The electrode assembly as claimed in claim 9, wherein the first insulating layer and the second insulating layer include a pigment and an insulating material, and the insulating material includes one of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU).

12. The electrode assembly as claimed in claim 9, wherein the first insulating layer and the second insulating layer include different materials.

13. The electrode assembly as claimed in claim 12, wherein the first insulating layer includes a pigment and an insulating material, the insulating material includes one of polyimide (PI), polyvinylidene fluoride, polyvinylidenefluoride-co-hexafluoropropylene (PVDF-HFP), polyacrylonitrile (PAN), polyethyleneimide (PEI), polypropylene (PP), polycarbonate (PC), and thermoplastic polyurethane (TPU), and the second insulating layer includes a ceramic.

14. The electrode assembly as claimed in claim 9, wherein the first insulating layer and the second insulating layer have different widths.

15. The electrode assembly as claimed in claim 9, wherein the first insulating layer and the second insulating layer are respectively adjacent to the first active material layer and the second active material layer, and are disposed at an edge of the substrate.

16. The electrode assembly as claimed in claim 15, wherein the first insulating layer is disposed at both sides of the first active material layer, the second insulating layer is disposed at both sides of the second active material layer, and the first insulating layer and the second insulating layer are continuously disposed along the first active material layer and the second active material layer, respectively.

17. An electrode comprising:
a substrate;
an active material layer that is disposed on at least one surface of the substrate; and
an insulating layer that is adjacent to the active material layer and is disposed on one surface of the substrate,
wherein the insulating layer includes a ceramic or has a color identifiable with the naked eye.
